(19) United States
(12) Patent Application Publication
(10) Pub. No.: US 2006/0210417 A1
(43) Pub. Date: Sep. 21, 2006

(54) Inscribed gear pump

(75) Inventors: Masakazu Kurata, Kanagawa (JP); Takumi Hisazumi, Kanagawa (JP); Mizuo Otaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Hitachi, Ltd.

(21) Appl. No.: 11/283,820

(22) Filed: Nov. 22, 2005

(30) Foreign Application Priority Data
Nov. 30, 2004 (JP) 2004-345071

(51) Int. Cl. F01C 1/02; F16N 13/20; F04C 2/00

(52) U.S. Cl. 418/61.3

(57) ABSTRACT

An inscribed gear pump that provides a housing, an outer rotor formed with a plurality of inner teeth continuously at an internal circumference thereof which is rotatably provided to an inside of the housing, an inner rotor formed with a plurality of outer teeth continuously at an external circumference thereof which is rotatably provided to an inside of the outer rotor, drive shaft rotatably drives the inner rotor. Volume chambers which are formed between the inner teeth and the outer teeth. A suction port is open at an area of the volume chamber increase in a volume gradually. A discharge port is open at an area of the volume chamber that decreases in a volume gradually. An area between a start portion of the suction port and an end portion of the discharge port have contact portions of the inner teeth and outer teeth, where the number is an integer more than 2 at a portion of a volume chamber having a maximum volume of a side of a trap portion.

### BACKGROUND OF THE INVENTION

The present invention relates to an inscribed gear pump as an oil pressure source for supplying an oil pressure to an anti-lock braking system or a power steering system of a vehicle.

A rotary pump is disclosed in Japanese non-examined publication JP-A-11-132157. According to the publication, an outer rotor that has plurality of inner teeth on a continuous internal circumference thereof, an inner rotor that has plurality of outer teeth on a continuous external circumference thereof which are engaged with the outer teeth. Volume chambers are located between the inner teeth and the outer teeth. One of the volume chambers, which is open at an area of a suction port, is located at one side of a trap portion having a maximum volume. Another volume chamber, which is opened at an area of a discharge port, is located at other side of a trap portion.

A side plate is provided to side portions of the inner rotor and the outer rotor. If a direction of the rotation is changed, they are structured housing for holding mesh portion at an opposite position.

A distance between a first suction port and a first discharge port is wide at the mesh portion, and is narrow at the un-mesh portion. On the other hand, a distance between a second suction port and a second discharge port is wide at the un-mesh portion, and is narrow at the mesh portion.

Because of this arrangement, if the rotation of the inner rotor is to be changed, only small parts need be changed so that a structure of each port is maintained. Therefore, a cost can be decreased.

In the foregoing pump, a volume chamber between a start portion of the suction port and an end portion of the discharge port has meshing portions of the inner teeth and outer teeth whose number are one or two at a portion of a volume chamber having a maximum volume of a side of a trap portion.

Therefore, a liner contact portion contacting the outer teeth of the inner rotor and the inner teeth of the outer rotor which has a seal for dividing suction into discharge can be case of one and case of two repetitions. That is, a characteristic of pump is changed, and a characteristic of the seal as the contact portion is unstable, as a result, oil can be easily leak from high pressure side to low pressure side.

### SUMMARY OF THE INVENTION

It is an object of present invention to provide an oil pump which has a characteristic of stability and does not have a characteristic of discharge by the direction of the rotation.

To achieve the above object, according to an aspect of the present invention, there is provided an inscribed gear pump that comprise a housing, an outer rotor formed with a plurality of inner teeth continuously at an internal circumference thereof which is rotatably provided to an inside of the housing, an inner rotor formed with a plurality of outer teeth continuously at an external circumference thereof which is rotatably provided to an inside of the outer rotor, a drive shaft which rotatably drives the inner rotor. Volume chambers which are formed between the inner teeth and the outer teeth. A suction port is open at an area of the volume chamber increase in a volume gradually. A discharge port is open at an area of the volume chamber that decreases in a volume gradually. An area between an end portion of the suction port and a start portion of the discharge port have contact portions of the inner teeth and outer teeth, where the number is an integer more than 2 at a portion of a volume chamber having a maximum volume of a side of a trap portion.

According to another aspect of the present invention, there is provided an inscribed gear pump that comprise a housing, an outer rotor formed with a plurality of inner teeth continuously at an internal circumference thereof which is rotatably provided to an inside of the housing, an inner rotor formed with a plurality of outer teeth continuously at an external circumference thereof which is rotatably provided to an inside of the outer rotor, a drive shaft which drives an inner rotor reversibly. Volume chambers which are formed between the inner teeth and the outer teeth. A first port and a second port are opened to the volume chambers between a mesh portion as minimum volume and a trap portion as a maximum volume, are positioned at a line of symmetry of an axis that connects between the mesh portion and the trap portion. An end portion of the first port and an end portion of the second port corresponding to the trap portion have a number of contact portions of the inner teeth and the outer teeth, where the number is an integer more than 2.

According to another aspect of the present invention, there is provided an inscribed gear pump that comprises a housing, an outer rotor, formed with a plurality of inner teeth continuously at an internal circumference continuous thereof which is rotatably provided to an inside of the housing, an inner rotor formed with a plurality of outer teeth continuously at an external circumference thereof which is rotatably provided to an inside of the outer rotor, a drive shaft which drives an inner rotor reversibly. Volume chambers which are formed between the inner teeth and the outer teeth. A first port and a second port which are opened to the volume chambers between a mesh portion as a minimum volume and a trap portion as a maximum volume, are positioned at a line of symmetry of an axis that connects between the mesh portion and trap portion, The outer teeth of the inner rotor is liner contacted with the inner teeth of the outer rotor at an end portion of the second port and an area between an end portion of the first port and an end portion of the second port has a number of contact portions of the inner teeth and outer teeth, where the number is an integer more than 2 at an end portion of the second port corresponding to the trap portion when the outer teeth of the inner rotor is liner contacted with the inner teeth of the outer rotor.

### BRIEF DESCRIPTION OF THE DRAWINGS

FIG. 1 shows of an enlarged view of FIG. 2 of an inscribed gear pump according to a first embodiment of the present invention.

FIG. 2 shows view taken on line A-A of FIG. 3.

FIG. 3 shows a cross sectional view taken on line B-B of FIG. 2.

FIG. 4 shows a characteristic of the first embodiment of the present invention and the relative art.

FIG. 5 shows a view taken on line C-C of FIG. 6 according to a second embodiment of the present invention.

FIG. 6 shows a cross sectional view taken on line D-D of FIG. 5.

### DETAILED DESCRIPTION OF THE INVENTION

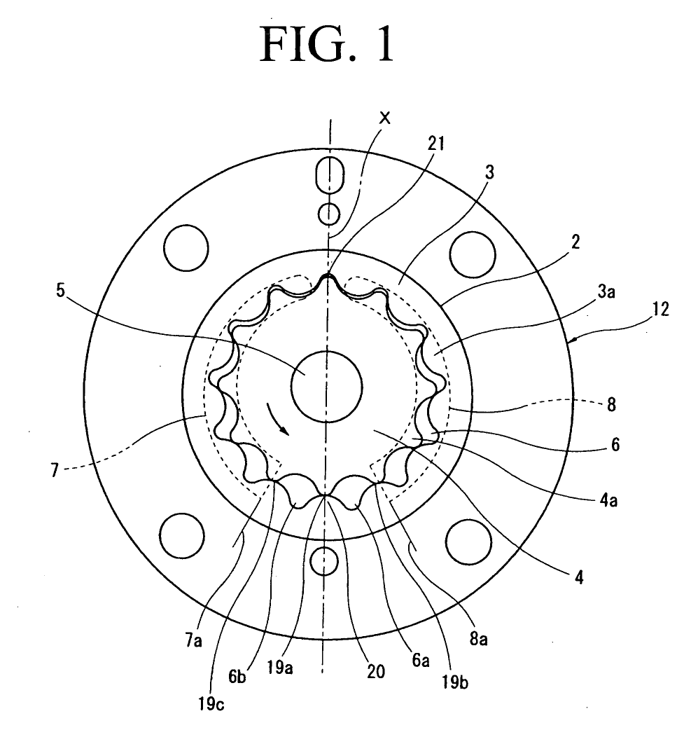

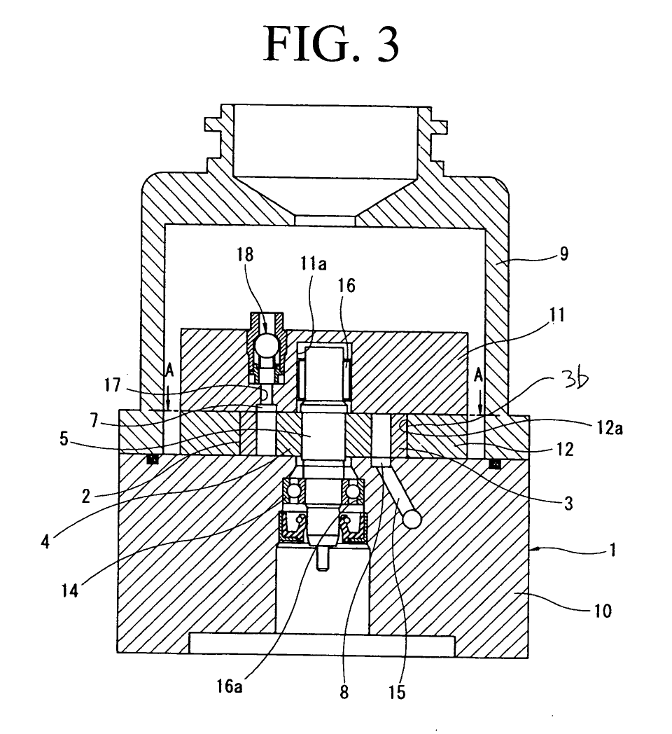

Referring to the drawings, a description is made of embodiments of the present invention. An inscribed gear pump, which is applied as a trochoid pump in this first embodiment, supplies an oil pressure which to an anti-lock braking system or a power steering system of a vehicle. FIG. 1 to FIG. 4 show a first embodiment of the present invention.

FIG. 1 to FIG. 3 show a trochoid pump which can rotate in a one-way direction. A power steering system has a fluid pressure cylinder. The pump supplies a pressure to a fluid pressure cylinder that provides for assisting power. The trochoid pump comprises a circumferential chamber 2 which is formed inside of a cam ring 12 which is part of a housing 1, An outer rotor 3, formed with a plurality of inner teeth 3a on a continuously internal circumference thereof, is rotatably provided inside of the housing 1, An inner rotor 4 formed with a plurality if outer teeth 4a on a continuously external circumference thereof, is rotatably provided inside of the outer rotor 3 and is engaged with the inner teeth 3a of the outer rotor 3. A drive shaft 5 rotatably drives the inner rotor 4. Volume chambers 6 are formed between the inner teeth 34 and the outer teeth 4a. A suction port 7 and a discharge port 8, which provide discharge and suction with respect to the volume chambers 6. The circumferential chamber 2 can be formed directly in the housing 1. And the inner rotor and the outer rotor are made from materials which have same liner expansion coefficients. Furthermore, preferably, the inner rotor and the outer rotor are made from sintered metal.

The suction port 7 and the discharge port 8 are located at one of the volume chambers that is formed between the inner teeth 3a and the outer teeth 4a, The two parts are disposed symmetrically with respect to an axis X that connects with a mesh portion 21 having a minimum volume and a trap portion 20 having a maximum volume. Each port is formed in almost the same shape, preferably an arc shape. The suction port 7 is provided at a portion where a volume of the chamber increases gradually. An opening area of the suction port 7 is formed so as to expand for along the direction of the rotation. The discharge port 8 is provided at a portion where a volume of the chamber decreases gradually. An opening area of the discharge port 8 is formed so as to reduce for a time along the direction of the rotation.

The housing 1 comprises a first side plate 10 of block shape that is made from aluminum alloy connecting with a reservoir tank 9 by bolts, and a second side plate 11 that is connected with one side of the first side plate 10 by bolts and faces to the inside of the reservoir tank 9. A cam ring 12 of a cylinder is provided tightly between each side plates. The housing 1 is installed into a reservoir tank 9.

Bolt holes 13 are drilled at the four comers of each of the side plates.

The first side plate 10 rotatably supports the end portion of the drive shaft 5 through a bearing 14 at a bearing hole 10a, and forms a discharge path 15 which connects with the discharge port 8. The discharge path 15 connects with a fluid pressure cylinder.

The second side plate 11 is thin and is formed in a block shape and is made of an aluminum alloy. The second side plate 11 rotatably supports another end portion of the drive shaft 5 through a bearing 16 at a bearing hole 11a, and forms a suction path 17 which connects with the suction port 7. The suction path 17 is connected with an inside of the reservoir tank 9 through a check valve 18.

Between an opposite surface of the first side plate 10 and the second side plate 11 and each side surface of the outer rotor 3 is a clearance for permitting a rotation of the outer rotor 3.

The cam ring 12 is formed in a ring shape having predetermined thickness and is made from sintered metal. A center of the cam ring 12 is eccentric, having a predetermined eccentricity from a center of the inner rotor 4. An outer face of the cam ring 12 faces to the inside of the reservoir tank 9. Between an inner surface 12a of the cam ring 12 and an outer surface 3b of the outer rotor 3 is a ring shaped clearance for obtaining a rotation of the outer rotor 3.

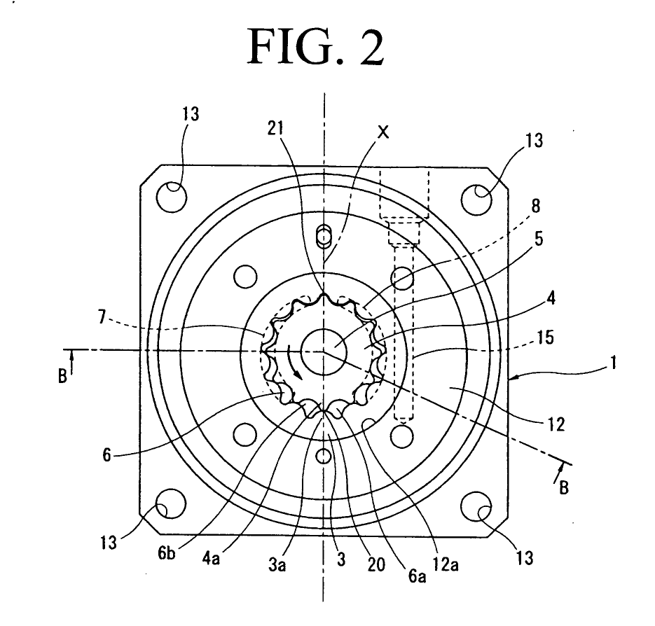

As illustrated in FIG. 1 and FIG. 2, the outer rotor 3 and the inner rotor 4 form the trap portion 20 where a tip of the inner teeth 3a and a tip of the outer teeth 4a contact each other with respect to the axis X. Volume chambers 6a, 6b of each side of the trap portion 20 are configured to have a maximum volume. In this situation, each volume chamber 6a, 6b does not connect with each port 7, 8.

Thus, the trap portion 20 is located between an end portion 7a of the suction port 7 and a start portion 8a of the discharge port 8, having three contact portions forming a line of contact. The three contact portions define the trap portion 20 and portions where the inner teeth 3a and the outer teeth 4a contact at each side of the trap portion 20. These contact portions are shown portions 19a, 19b 19c in FIG. 1. The end portion of the suction port and the start portion of the discharge port are formed in a radial direction.

The inner teeth 3a and the outer teeth 4a, at opposite portions of the trap portion 20 with respect to the axis X, where the volume chamber 6 has a minimum volume, are deeply engaged with each other.

The drive shaft 5 is driven in a direction of rotation for driving the inner rotor 4 and the outer rotor 3 by an electric motor that is not shown. By driving the inner rotor 4 and the outer rotor 3, oil is suctioned from the suction port 7 to the volume chamber 6, with increasing or decreasing a volume of the volume chamber 6. The oil passing through the trap portion 20 having a maximum volume is discharged to the discharged path 15 from the discharge port 8.

When the inner rotor 3 and the outer rotor 4 are rotatably driven clockwise by the electric motor 5, the oil is suctioned from the suction port 7 to each volume chamber 6, and passes to the trap portion 20. Consequently, pressurized oil is discharged from the discharge port 8 to the discharge path 15. The oil is selectively discharged and suctioned by a valve of a fluid pressure chamber of the fluid pressure cylinder

In this embodiment, the number of outer teeth 4a of the inner rotor 4 can be three at an area between the end portion 7a of the suction port 7 and the start portion 8a of the discharge portion 8. Therefore, the number of the line contact portions 19a, 19b, 19c between the inner teeth 3a of the outer rotor 3 and the outer teeth 4a of the inner rotor 4 can be three at the area between each port 7, 8.

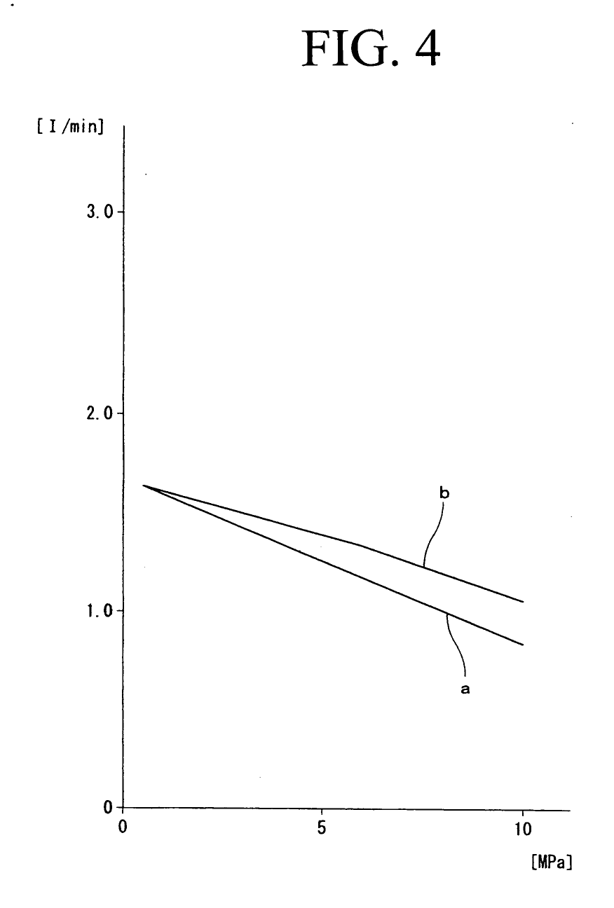

Accordingly, since the number of contact portions is three, a change of a characteristic of the pump can be control minimum. That is, a sufficient seal of an area between the suction port 7 and the discharge port 8, in other words a neighborhood of the trap portion 20, can be obtained. The amount of leaking of the oil at a high pressure decreases from the side of discharge, which has a high pressure to the side of suction, which has a low pressure. As a result, as seen in FIG. 4(b), there is less of a decline of the efficiency, as seen by line b, as compared with related, art as seen by line a.

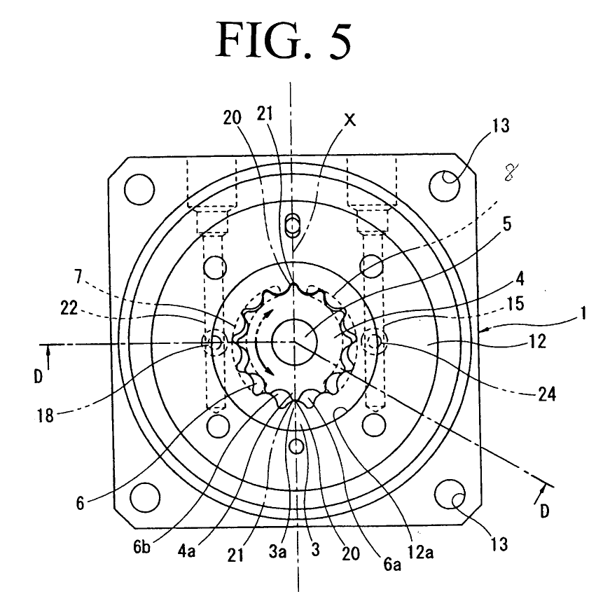

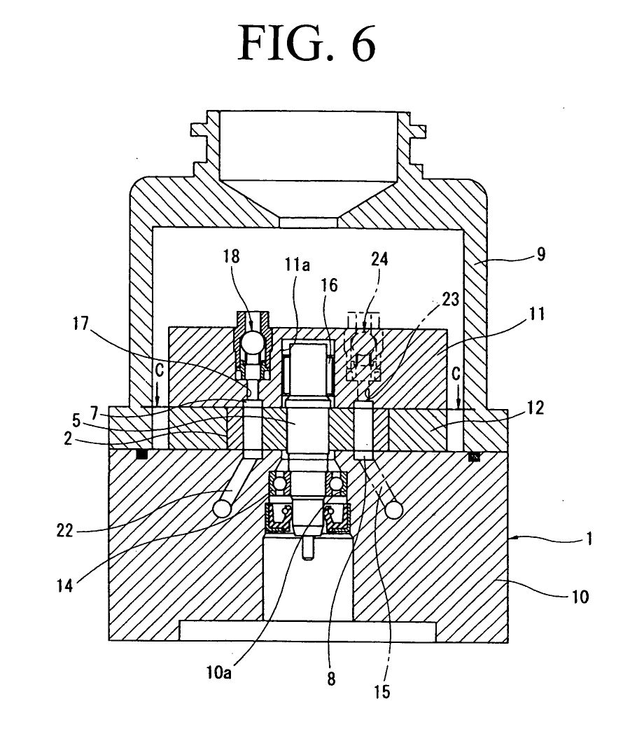

FIG. 5 and FIG. 6 show a second embodiment of the present invention. The present invention applied to a reversible pump in which the inner rotor 4 and the outer rotor 3 can be rotated in each direction by the electric motor.

The first port 7 and the second port 8 can be formed opposite, relative to the direction of the each rotor 3, 4. When each rotor rotates a turn clockwise (an arrow of actual line in FIG. 5), the first port 7 becomes a suction port and the second port 8 becomes a discharge port. On the other hand, when each rotor rotates a clockwise (an arrow of dot line in FIG. 5), the first port 7 becomes a discharge port and the second port 8 becomes a suction port. A suction path 23 connects with the second port 8 and a discharge path 22 connects with the first port 7. The suction path 23 connects with the inside of the reservoir tank 9 through the check valve 24.

When each rotor 3, 4 is rotated in a direction opposite to the first embodiment, the trap portion 20 and the mesh portion 21 is located as seen in FIG. 5. In this case, the number of the outer teeth 4a of the inner rotor 4 can be three at an area between the end portion 7a of the suction port 7 and the start portion 8a of the discharge portion 8. Therefore, the number of the line contact portions 19a, 19b, 19c between the inner teeth 3a of the outer rotor 3 and the outer teeth 4a of the inner rotor 4 can be three at the area between each port 7, 8.

The first port 7 and the second port 8 are symmetrically formed with respect to the axis X, and each port 7, 8 is formed in the same shape and has the same size. These ports 7, 8 can use the first embodiment one because these ports 7, 8 are the same as the first embodiment.

Therefore, in this embodiment as applied to a reversible pump, a discharge characteristic of the pump is stable and has the same characteristic with respect to each direction of rotation of each rotor 3, 4.

In the first and second embodiments, the number of the line contact portions is three, but the number of the line contact portions between the inner teeth 3a of the outer rotor 3 and the outer teeth 4a of the inner rotor 4 should be more than two at the area between each port 7, 8. That is, the line contact portions can be three portions or four portions.

The entire contents of Japanese Patent Application P2004-345071 filed Nov. 30, 2004 are incorporated herein by reference.

What is claimed is:

1. An inscribed gear pump comprising;
a housing,
an outer rotor formed with a plurality of inner teeth continuously at an internal circumference thereof which is rotatably provided to an inside of the housing,
an inner rotor formed with a plurality of outer teeth continuously at an external circumference thereof which is rotatably provided to an inside of the outer rotor,
a drive shaft which rotatably drives the inner rotor,
volume chambers which are formed between the inner teeth and the outer teeth,
a suction port, which is open at an area of the volume chamber increase in a volume gradually,
a discharge port, which is open at an area of the volume chamber that decreases in a volume gradually, and
wherein an area between an end portion of the suction port and a start portion of the discharge port have contact portions of the inner teeth and outer teeth, where the number is an integer more than 2 at a portion of a volume chamber having a maximum volume of a side of a trap portion.

2. The inscribed gear pump as claimed in claim 1,
wherein the end portion of the suction port and the start portion of the discharge port are formed in a radial direction of the radiation.

3. The inscribed gear pump as claimed in claim 1,
wherein the inscribed gear pump defines a trochoid pump which has a trochoid curved line at the inner teeth and the outer teeth.

4. The inscribed gear pump as claimed in claim 1,
wherein the inner rotor and the outer rotor are each made from materials which have the same liner expansion coefficients.

5. An inscribed gear pump comprising;
a housing,
an outer rotor formed with a plurality of inner teeth continuously at an internal circumference thereof which is rotatably provided to an inside of the housing,
an inner rotor formed with a plurality of outer teeth continuously at an external circumference thereof which is rotatably provided to an inside of the outer rotor,
a drive shaft which drives an inner rotor reversibly,
volume chambers which are formed between the inner teeth and the outer teeth,
a first port and a second port, which are opened to the volume chambers between a mesh portion as minimum volume and a trap portion as a maximum volume, are positioned at a line of symmetry of an axis that connects between the mesh portion and the trap portion, and
wherein an end portion of the first port and an end portion of the second port corresponding to the trap portion have a number of contact portions of the inner teeth and the outer teeth, where the number is an integer more than 2.

6. The inscribed gear pump as claimed in claim 5,
wherein the portion of the first port and the portion of the second port are formed in a radial direction.

7. The inscribed gear pump as claimed claim 5,
wherein the housing comprises a cam ring provided to an external circumference of the outer rotor, and a first side plate and a second side plate provided to each axial side of the cam ring.

8. The inscribed gear pump as claimed in claim 7,
wherein the first port and the second port are formed at the first side plate and the second side plate, respectively.

9. The inscribed gear pump as claimed in claim 5,
wherein the inscribed gear pump defines a trochoid pump which has a trochoid curved line at the inner teeth and the outer teeth.

10. The inscribed gear pump as claimed in claim 5,
wherein the inner rotor and the outer rotor are each made from materials which have the same liner expansion coefficients.

11. The inscribed gear pump as claimed in claim 10,
wherein the inner rotor and the outer rotor are made from sintered metal.

12. The inscribed gear pump as claimed in claim 5,
wherein the drive shaft is driven by an electric motor.

13. An inscribed gear pump comprising;
a housing,
an outer rotor, formed with a plurality of inner teeth continuously at an internal circumference continuous thereof which is rotatably provided to an inside of the housing,
an inner rotor formed with a plurality of outer teeth continuously at an external circumference thereof which is rotatably provided to an inside of the outer rotor,
a drive shaft which drives an inner rotor reversibly,
volume chambers which are formed between the inner teeth and the outer teeth,
a first port and a second port which are opened to the volume chambers between a mesh portion as a minimum volume and a trap portion as a maximum volume, are positioned at a line of symmetry of an axis that connects between the mesh portion and trap portion, and
wherein the outer teeth of the inner rotor is liner contacted with the inner teeth of the outer rotor at an end portion of the second port and an area between an end portion of the first port and an end portion of the second port has a number of contact portions of the inner teeth and outer teeth, where the number is an integer more than 2 at an end portion of the second port corresponding to the trap portion when the outer teeth of the inner rotor is liner contacted with the inner teeth of the outer rotor.

14. The inscribed gear pump claimed in claim 13,
wherein the portion of the first port and the portion of the second port are formed in a radial direction.

15. The inscribed gear pump as claimed claim 13,
wherein the housing comprises a cam ring provided to an external circumference of the outer rotor, and a first side plate and a second side plate provided to each axial side of the cam ring.

16. The inscribed gear pump as claimed in claim 15,
wherein the first port and the second port are formed at the first side plate and the second side plate, respectively.

17. The inscribed gear pump as claimed in claim 13,
wherein the inscribed gear pump defines a trochoid pump which has a trochoid curved line at the inner teeth and the outer teeth.

18. The inscribed gear pump as claimed in claim 17,
wherein the inner rotor and the outer rotor are each made from materials which have same liner expansion coefficients.

19. The inscribed gear pump as claimed in claim 13,
wherein the inner rotor and the outer rotor are made from sintered metal.

20. The inscribed gear pump as claimed in claim 13,
wherein the drive shaft is driven by an electric motor.
